(19) United States
(12) Patent Application Publication
(10) Pub. No.: US 2019/0010736 A1
(43) Pub. Date: Jan. 10, 2019

(54) AIR BRAKE VALVE SAFETY AND SECURITY GUARD

(71) Applicant: Byron John Pixton, Sandy, UT (US)

(72) Inventor: Byron John Pixton, Sandy, UT (US)

(21) Appl. No.: 15/644,678

(22) Filed: Jul. 7, 2017

(51) Int. Cl. E05B 79/02; B60T 15/04; E05B 77/00; B60T 17/18; B60T 7/10

(52) U.S. Cl. CPC E05B 79/02; B60T 15/041; B60T 7/101; B60T 17/18; E05B 77/00

(57) ABSTRACT

A safety device for vehicles with air brakes that can be attached in conjunction with a parking brake that will provide protection from unintended brake releases due to the parking brake control valve knob being bumped or pushed. The said invented guard can also be locked for security and theft protection.

### BACKGROUND

Application field of patent classification; Automotive vehicle, parking brake, air brake, safety, guard, security device.

There are two problems with many vehicles equipped with air parking brakes. Since many vehicles with air brakes have located the parking brake control knob in close proximity to the drivers knees thereby making the parking brake valve vulnerable to accidental bumping and thereby releasing of the brake. Many parking brakes can also be released by unauthorized people, such as a student on a school bus.

The invention is therefore intended to prevent two problems with vehicles equipped with air brakes and that have a parking brake knob that is mounted on a vehicles dashboard. The first problem the invented guard may prevent is accidental bumping of parking brake control valve knob that can cause unintended parking brake releases. The second problem that the invented guard may prevent is unwanted intentional parking brake releases.

The said invented guard will protrude in front of the parking brake knob to act as a guard and protect said knob from being accidentally bumped. By protecting the parking brake, the said device will help prevent accidental brake releases.

The guard may also have hole on each side to facilitate a locking device or may otherwise be made so that a locking device may be attached or applied that will prevent the parking brake knob from being pushed or disengaged while locked.

### BRIEF SUMMARY OF THE INVENTION

The unique features of the invention as claimed are; a device made of metal or plastic or other materials that can be fastened in proximity to a parking brake control valve knob and protrudes out in front of said knob that will protect the parking brake from accidental bumping while the brake is pulled out and set in the braking position. The said invented guard is also designed to allow a locking device to be applied to the parking brake knob so that the knob cannot be depressed while the lock is applied.

### DESCRIPTION OF THE DRAWING

FIG. 1 shows an example of what the invented guard might look like mounted on a vehicle.

### DETAILED DESCRIPTION OF EMBODIMENT

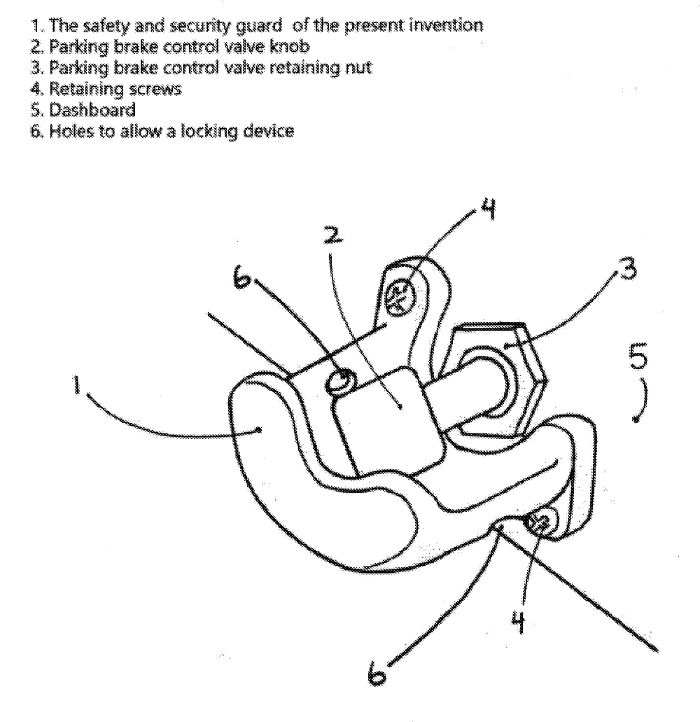

FIG. 1 shows a perspective view of the present invention in an assembled state.
1. Shows what said invented guard may look like. This illustration shows the guard that could be cast or cut in a variety of materials, such as but not limited to plastic or aluminum. The base of said guard is attached to the part of the vehicle (5) that the parking brake control valve is attached to. The base of the invented guard having holes to allow the said guard to be attached to said vehicle surface by means of screw, rivets, or other attaching device. The body of said guard protrudes outward from said vehicle surface past the parking brake knob and in front of the said knob. The said guard body runs perpendicular to the front surface of the said knob.
2. Shows a typical parking brake knob for a vehicle with air brakes.
3. Shows a typical mounting nut for a parking brake with air brakes.
4. Shows screws for mounting the said device body to the dashboard or surface that the parking brake is mounted to (5). while the illustration shows screws being used to mount the said device to the dashboard, other means may be used to fasten the part to the dashboard such as but not limited to rivets, adhesives, a flange that fits under the parking brake mounting nut (3), or as part of the said guard body, replaces and acts as the mounting nut to fasten both the said guard body and the parking brake assembly to the dashboard or the surface that the parking brake is mounted to (5).
5. Indicates a dashboard or the part of the vehicle being the surface that the parking brake control valve is mounted to.
6. Indicates holes in the said guard body that can be used to attach a lock that will secure the parking brake knob in the engaged position.

Having described my invention, I claim:

1. A guard that can be installed on vehicles equipped with air brakes that will;
1. Mount in proximity to the parking brake control valve knob, and protrude in front of said knob and act as a guard to protect the parking brake control valve knob from being bumped by persons or objects accidentally.
2. Allow for a locking device to be attached to or mounted on the said guard body that can secure and lock the parking brake knob while it is in the engaged position.
